(19) United States
(12) Patent Application Publication
(10) Pub. No.: US 2023/0316763 A1
(43) Pub. Date: Oct. 5, 2023

(54) FEW-SHOT ANOMALY DETECTION

(71) Applicant: Active Intelligence Corp, Hamburg, NJ (US)

(72) Inventor: Lei Wang, Symonston (AU)

(73) Assignee: Active Intelligence Corp, Hamburg, NJ (US)

(21) Appl. No.: 18/194,050

(22) Filed: Mar. 31, 2023

Related U.S. Application Data
(60) Provisional application No. 63/326,525, filed on Apr. 1, 2022.

(51) Int. Cl. G06V 20/52; G06V 20/40; G06V 10/774

(52) U.S. Cl. CPC G06V 20/52; G06V 20/40; G06V 10/774

(57) ABSTRACT

A computer implemented method for real-time anomaly detection from video streaming data, and/or finding anomaly video frames from stored videos, includes meta learning: using the videos collected from multiple scenes that contains only normal/common activities; training from a larger number of few-shot scene-adaptive anomaly detection tasks, where each task corresponds to a particular scene, in each task learning to adapt a pre-trained future frame prediction model using a few frames from a corresponding scene; meta fine-tuning: the meta-learner being used to adapt a pre-trained model to the scene, the adapted model working on other frames from this target scene, the few frames of the new target scene are obtained during a camera calibration process; building a model to learn the future frame prediction/reconstruction and the anomaly detection is determined by the difference between a predicted/reconstructed frame and the actual frame.

### CROSS-REFERENCE TO RELATED APPLICATION

This application claims priority to U.S. Provisional Patent Application No. 63/326,525 filed Apr. 1, 2022, having the same inventorship and title as the instant application, the contents of which are incorporated herein by reference. All available rights are claimed, including the right of priority.

### BACKGROUND OF THE INVENTION

### 1. Field of the Invention

The invention generally relates to video monitoring and surveillance systems and, more specifically, to a real time video anomaly detection and alerting system.

### 2. Description of the Prior Art

Video display walls inside command centers provide an illusion of real-time situational awareness. However, human beings are incapable of monitoring more than one display at a time. As a result, officers in command centers remain blind to events playing out before them. The images displayed on video monitors in command centers convey amount to little more than video “noise.”

A multitude of video analytics products have been created for the security and law enforcement markets.

To fully appreciate the present invention's advancements over the prior art systems, the following is a list of traits generally shared by known or prior art analytics systems:
Post-Event—The vast majority of video analytics tools currently on the market are forensic in nature, designed to assist post-event investigations. (A handful of systems offer limited real-time capabilities, such as searching for a specific person or vehicle, but then only for a very limited number of camera streams, users and hours of recorded video per month.)
Rules-Based—These systems stand idle until input has been received from officers that explicitly define what people, objects or events are to be searched for.
Narrow Focus—When told to “find the man in the red sweater,” these systems do exactly that—to the exclusion of everything else that may be happening across the network.
Resource Intensive—Prior art systems using machine learning/deep learning methodologies are “compute expensive.” These neural network-focused systems' brute force approach to video analytics results in computing resources—especially GPUs—being “gobbled” at a significant rate.
Reliance on 3^{rd}-Party Data—Task-specific analytics, e.g., facial and license plate recognition, require external data sources, which result in increased dependencies, licensing issues and expense.
Complexity—System installation, configuration and administration must be performed and/or supported by Security Integrators or by the factory.
Intrusive Tech—Municipalities and other entities have begun to push-back on (and even ban) the use of surveillance technologies that may be used to violate the privacy of individuals (e.g., profiling).
No-Edge/Cloud—GPU-hungry, server dependent systems do not readily lend themselves to either camera or cloud-based deployments.

An example of a prior art anomaly detection system is disclosed in U.S. Pat. No. 8,744,124 for systems and methods of detecting anomalies from data. The patent discloses methods and/or systems for processing, detecting and/or notifying for the presence of anomalies or infrequent events from data and large-scale data sets. Certain applications are directed to analyzing sensor surveillance records to identify aberrant behavior. The sensor data may be from a number of sensor types including video and/or audio and may use compressive sensing. Certain applications may be performed in substantially real time. The disclosed method includes the steps of processing, detecting and/or notifying for the presence of at least one infrequent event from at least one large scale data set includes receiving time series data; representing either the time series data, or one or more features of the time series data, as sets of vectors, matrices and/or tensors; performing compressive sensing on at least one vector, matrix and/or tensor set; decomposing the compressive sensed vector, matrix and/or tensor set to extract a residual subspace; and identifying, using a computing device, potential infrequent events by analyzing compressive sensed data projected into a residual subspace. However, the architecture uses handcrafted features i.e., using fisher vectors, bag-of-words, etc. and uses block-based architecture, and the output from one block is fed into the next block for further processing (which is time-consuming). Also, the proposed meta-learning framework can be used in conjunction with any anomaly detection model as the backbone architecture. The method classifies anomalies based on the handcrafted features, and it is not transferable. The method requires training data that contains both normal and abnormal videos. The method requires a reasonable number of videos for training thus guaranteeing reasonable performance. The method further requires each input video to have fixed length of video frames, say 32-frame or 64-frame, etc. Handling video subsequences enjoys the advantages of (i) identify anomalies in real-time (ii) efficient data usage (iii) supports future extension on more fine-grained action recognition, etc. The method uses the locality-sensitive hashing (LSH) for grouping the spatio-temporal features. The method for video data classification uses the following process: spatiotemporal feature extraction, feature fusion, feature encoding using Gaussian Mixture Model (GMM), feature selection by Fisher score, LSH for feature grouping, lookup table for video data retrieval. The method focuses more on post-filtering. The method requires different trained models for different scenarios, i.e., a model for car parking, a model for shopping model, a model for coffee shop, etc.

U.S. Published Application 20210097438 is for an anomaly detection device, method and detection program. One embodiment of an anomaly detection device includes a predicted value calculation unit, an anomaly degree calculation unit, a second predicted value calculation unit, a determination value calculation unit, and an anomaly determination unit. The first predicted value calculation unit calculates a first model predicted value from a correlation model obtained by first machine learning, the anomaly degree calculation unit calculates an anomaly degree, the second predicted value calculation unit calculates a second model predicted value from a time series model obtained by second machine learning, the determination value calculation unit calculates a divergence degree, and the anomaly determination unit determines whether an anomaly occurs or not. The anomaly detection device includes: a data input unit acquiring system data output from at least one anomaly detection target; a data processing unit generating time series monitoring data, based on the system data; a first predicted value calculation unit calculating a first model predicted value from input monitoring data and a correlation model obtained by first machine learning using the monitoring data; an anomaly degree calculation unit calculating an anomaly degree indicative of a magnitude of an error between a value of the input monitoring data and the first model predicted value and outputting anomaly degree time series data which is time series data; a second predicted value calculation unit calculating a second model predicted value to the anomaly degree from a time series model obtained by second machine learning different from the first machine learning, using the anomaly degree time series data; a determination value calculation unit calculating a divergence degree indicative of a magnitude of an error between the anomaly degree and the second model predicted value to the anomaly degree; and an anomaly determination unit determining whether an anomaly occurs at the anomaly detection target or not, based on one of the anomaly degree and the divergence degree. However, this publication focuses more on detecting anomalies in time series, and the model is complicated in terms of determining the anomalies and is a learning and calculation for anomaly detection.

US Published patent application US20210304035 discloses a method and system to detect undefined anomalies in processes and describes a method to detect anomaly in an environment based on AI techniques. The method includes receiving one or more data representations of one or more objects present in an environment. A first-type of information is captured from a first-area within the one or more data representations. A second-type of information from a second-area different than the first area in the data representations is also captured. A third information is generated from the first information and corresponds to predicted information for the second area using one or more artificial-intelligence models for evaluating the second information. The third information is compared with the second information to determine abnormality with respect to state or operation of one or more objects within the environment. The method to capture and label an undefined anomaly in an environment based on AI techniques includes the steps of executing a single media or multimedia file denoting an operation or state with respect to at least one object for a predefined time period; capturing un-labelled data based on the execution of the file and splitting the captured unlabeled data into a plurality of sub data-sets; automatically labelling at least one sub-data set as a Ground Truth label and capturing one or more features from one or more sub datasets other than labelled sub dataset; conducting a supervised machine learning (ML) based training iteratively for each of a plurality of AI models based on: predicting labels of the one or more sub datasets based on the captured features; and comparing predicted labels of the one or more sub datasets against the labelled dataset; and aggregating the plurality of trained AI models to enable capturing of abnormality with respect to the operation or state of the at-least one object. However, the system uses multiple sensor data (i.e., audios, images, videos, etc.) for anomaly detection in an environment that contains much pre-processing for the sensor data before the learning stage, and uses a supervised machine learning method (i.e., labelling the data is a must). The results from multiple models are combined (ensemble learning) to form a final prediction of anomaly.

### SUMMARY OF THE INVENTION

The invention is for a real-time video anomaly detection technology that will deliver greater value and ROI than other technologies currently offered in the video surveillance market. The ability to model, detect and alert security officers in real-time to unwanted events is unprecedented.

The invention identifies unusual behaviors by learning exclusively from normal videos. To detect anomalies in a previously unseen scene with only a few frames, a meta-learning based approach is used for solving this problem. The training and testing phases include:

Training phase: videos are collected from multiple scenes (e.g., shopping mall, airport, car parking area, etc.).
The model is trained from a larger number of few-shot scene-adaptive anomaly detection tasks, where each task corresponds to a particular scene.
In each task, the method learns to adapt a pre-trained future frame prediction model using a few frames from a corresponding scene. The training videos only contain normal frames and videos.
input: videos come from various scenarios (the model receives only normal videos as inputs), the training data here can be obtained from online videos (e.g. Youtube), existing benchmark anomaly detection datasets, stored historical videos captured from different sites, etc.
output: predicted next frame (with the same resolution as the inputs)

For training, the input/output should be in the form of (x, y), where x=(I₁, I₂, . . . , Iₜ₋₁₎ is a sequence of video frames used for predicting the next frame and y=Iₜ represents the ground truth next frame.

Test phase: Given a few frames from a new target scene (e.g., coffee shop which does not appear in the training data), the meta-learner is used to adapt a previously pre-trained model to this scene. Then the adapted model is expected to work well on other frames from this target scene. The few frames of the new target scene can be obtained during a camera calibration process.

The proposed meta-learning framework can be used in conjunction with any anomaly detection model as the backbone architecture. A model is built to learn the future frame prediction/reconstruction, then the anomaly detection is determined comparing by the difference between the predicted/reconstructed frame and the actual ground truth frame. If the difference is larger than a pre-defined threshold, this frame is considered to be an anomaly otherwise, it is a normal frame.

Initially, the input videos are (i) resized to a reasonable lower resolution (e.g., 224×224) depending on the use case/scenario or (ii) cropped based on the regions of interest to:
reduce the computational cost at an earlier stage
identify anomalies as quickly as possible

The full resolution videos are later to be further analyzed (e.g., object detection, action recognition and tracking, etc.) only if the anomaly has been detected during the anomaly detection stage.
input: the resized and/or cropped few video frames from the new scene after deploying, the number of input frames can be e.g., 3, 5 or 10 depends on the use case/scenario.
output: the predicted next frame (with the same video resolution as the inputs).

The output predicted frame is further compared to the actual ground truth frame that comes from the video streaming.

### BRIEF DESCRIPTION OF THE DRAWINGS

The following descriptions are in reference to the accompanying drawings in which the same or similar parts are designated by the same numerals throughout the several drawings, and wherein:

FIG. 1 is a schematic representation of the overall architecture of an anomaly detection system;

FIG. 2 is a schematic representation of the training process of the anomaly detection system;

FIG. 3 is a flow chart illustrating the training process of the anomaly detection system;

FIG. 4 is a flow chart illustrating the video sampling process of the training of the anomaly detection system.

FIG. 5 is a schematic representation of the fine-tuning process of the anomaly detection system;

FIG. 6 is a flow chart illustrating the fine-tuning process of the anomaly detection system;

FIG. 7 is a schematic representation of the test process of the anomaly detection system;

FIG. 8 is a flow chart illustrating the test process of the anomaly detection system; and

FIG. 9 illustrates the use of the invention using Cloud-Based Architecture.

### DETAILED DESCRIPTION OF THE INVENTION

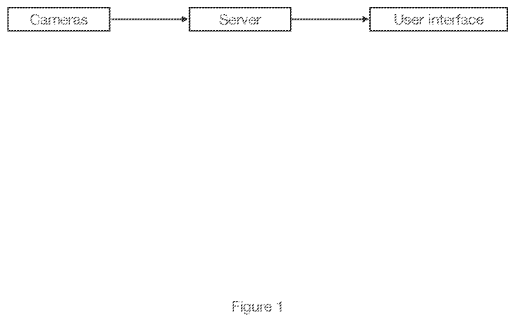

Referring now to the Figures, and first referring to FIG. 1 the overall architecture of the few-shot anomaly detection system is generally designated by the reference 10.

The system 10 typically includes a plurality of cameras 12 that generate a pre-determined number of input video streams to a server 14 that processes the video streams the output of which is input to a user interface 16.

For purposes of the description that follows a “shot” is defined as a single take that typically takes several seconds to several minutes and consists of a plurality of “frames”. A “scene” is a sequence of shots and, therefore, is composed of a plurality of shots. A “sequence” is made up of a plurality of scenes. A “video” is composed of a plurality of sequences. A “video block” is a sequence of shots having a same number of frames.

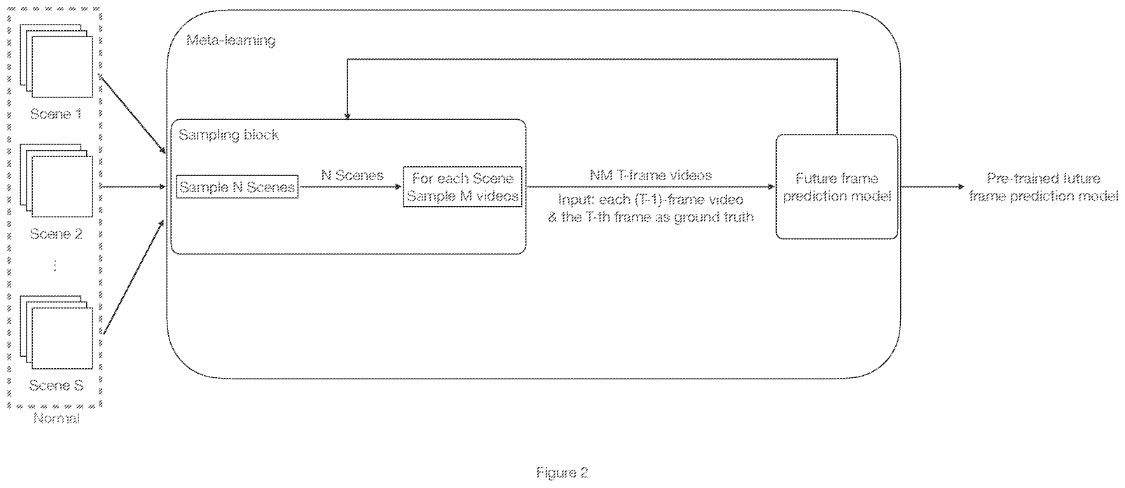

Referring to FIGS. 1 and 2 the components and flowchart, respectively, are illustrated for the training process. Initially, a plurality of scenes 20 are used, including scenes 1, 2, S. For initial training the videos are all normal scenarios without anomalies. The scenes are received as video streams from different scenarios/sites/camera viewpoints. The video streams are input to a sampling block 22 where a predetermined number of videos per scenarios are sampled. The sampling block 22 samples N scenes at 24 and the N scenes 26 are then sampled at 28 where for each scene M videos are sampled. The output 30 of the sampling block 22 includes NM T-frame videos, the input is (T−1)-frame video, and the T-th frame being considered as “ground truth”. The sampled videos of further pre-processed 2 video blocks, each with the same number frames. The last frame per video block, therefore, is used as the ground truth frame and the rest of the frames are used for the production of the last frame. The video blocks are input to a future frame prediction model 32 for the future frame prediction. The proposed model is independent of the choice of the future frame prediction model and the frame prediction model can be, for example, a recurrent neural network for spatial-temporal prediction that has convolutional structures in both the input-to-state and state-to-state transitions (ConvLSTM) with adversarial training. The model 32 consists of a generator and a discriminator and a U-Net to predict the future frame and pass the prediction to the ConvLSTM module to retain the information.

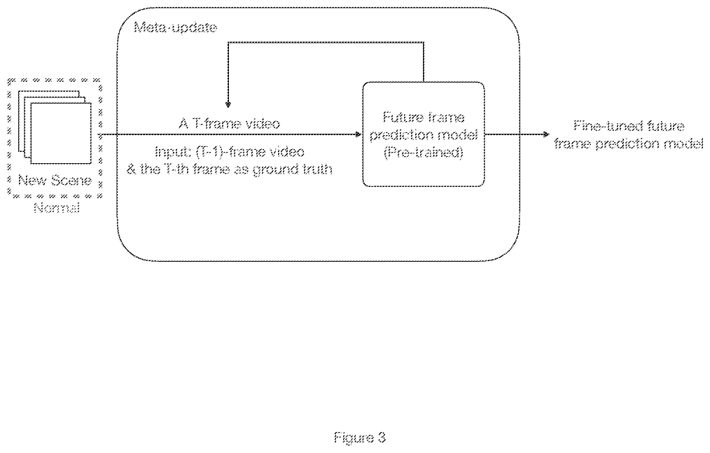

Referring to FIG. 3, the flowchart is illustrated for the training process shown in FIG. 2. At the start 36 the videos are input to the video sampling algorithm 38. The videos are input at 40 and the software determines whether there are enough or sufficient scenarios at 42. If it is determined that there are insufficient scenarios the system reverts to the input of 40 to collect more scenarios. On the other hand, if it is determined that there are enough or sufficient scenarios the system tests for the sufficiency of the number of videos per scenario at 46. If there are insufficient videos per scenario the system reverts to the input at 42 to collect additional videos per scenario. If it is determined that there are sufficient videos per scenario these are sampled at 50 and the sampled videos are stored at 52 in Database 1, item 54. The sampled videos at 50 together with videos stored in Database 1, at 54, are input to a future frame prediction 56. After the future frame prediction is made, at 56, the pre-trained model is stored at 58 into the Database 2, at 60.

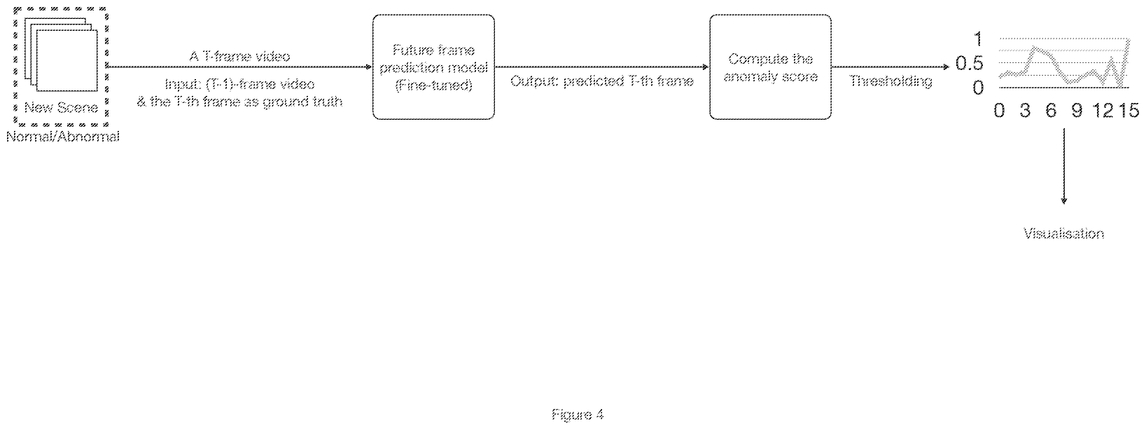

The video sampling flowchart is illustrated in FIG. 4, corresponding to the sampling in the sampling block shown in FIG. 2. Thus, once scanning starts the videos are received at 62 from the Database 1, at 54, and tested at 64 to determine and ensure that the videos are “normal” videos or videos that do not exhibit anomalies. If the videos are determined not to be normal because they contain anomalies the video software loops, at 66, to the start to continue to test the nature of the videos. If it is determined, at 64, that the videos are normal the videos are sampled for N scenarios, at 68, and subsequently sampled for M videos per scenario, at 70, as suggested in FIG. 2. FIGS. 2 and 3, therefore, represent or illustrate the training process. Once the model is trained, the pre-trained model is stored in a Database 2, at 60, as indicated. This represents the meta-learning process.

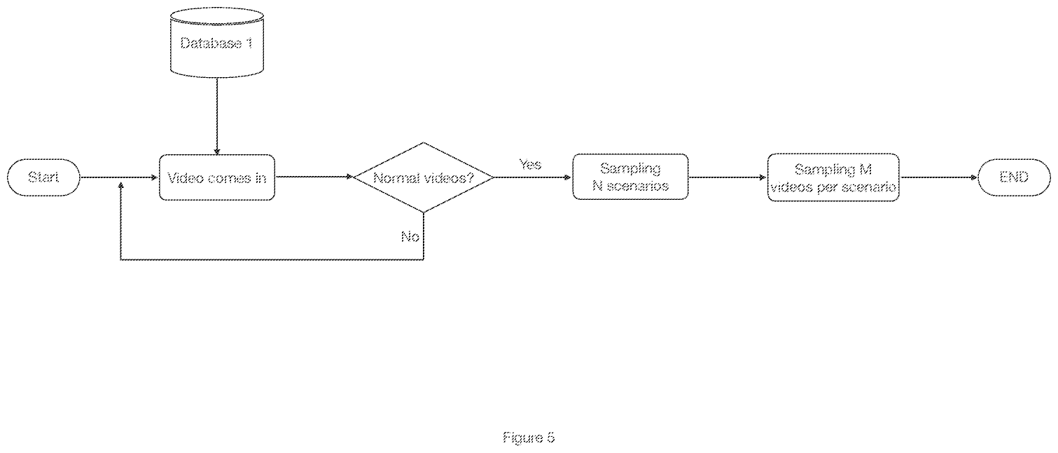

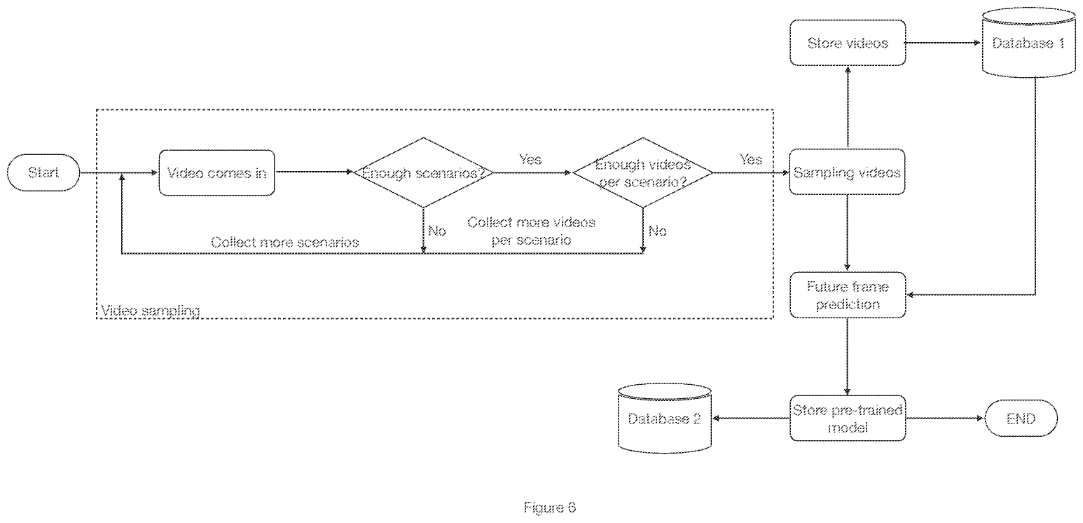

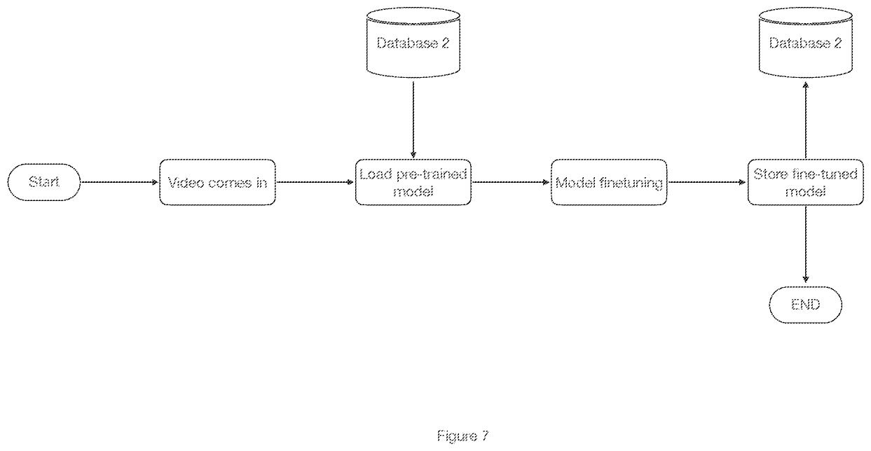

After the training process has been completed it is fine-tuned, as illustrated in FIG. 5. The flowchart for the fine-tuning process is illustrated in FIG. 6. The fine-tuning process 72 is illustrated in FIG. 5. A new “normal” scene at 74, from a new video stream from a different scenario/site/camera viewpoints is sampled as suggested in FIG. 2 to generate a T-frame video at 76, wherein (T−1)-frame video is input, and the T-th frame are the “ground truth” and input to the future frame prediction model (pre-trained) 78, the output 82 of which represents the fine-tuned future frame prediction model. In FIG. 7, the video is received at 86. As indicated, the initial frames are “normal” frames without anomalies. The videos are pre-processed to video blocks the same as in the training process. The last frame per video block is used as the “ground truth” frame and the rest of the frames are used for the prediction of the last frame. The pre-trained future frame prediction model is loaded, at 88, from the Database 2, at 60. The video blocks are passed to the future frame prediction model 78 (FIG. 5) for future frame prediction. This is the process of fine-tuning and meta-update at 90. The fine-tuned model is stored in Database 2, at 60.

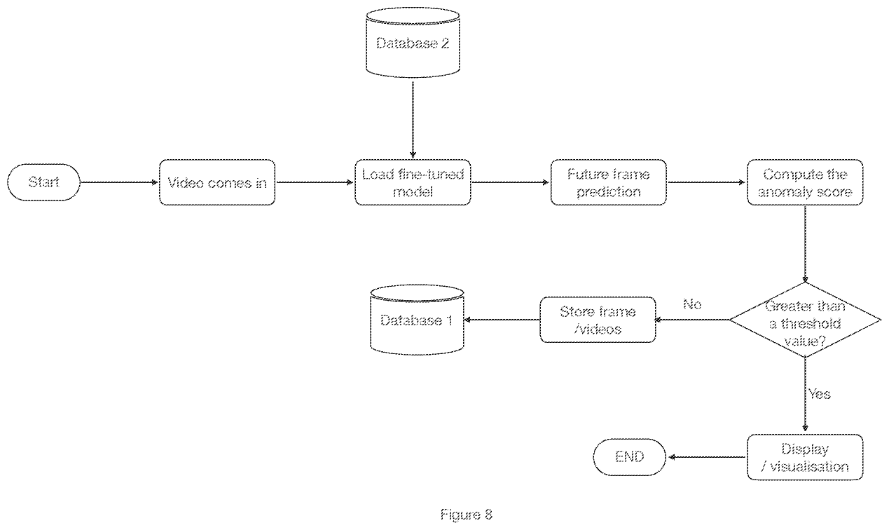

FIG. 7 illustrates the test process, and the associated flowchart is shown in FIG. 8. In FIG. 7 a video stream is received, at 96, from the same scenario/site/camera viewpoint as the fine-tuning process shown in FIGS. 5 and 6. The video stream may or may not contain anomalies so that the video stream may be normal, as in the previous training and in fine-tuning sequences, or abnormal. A T-frame video, at 98, includes a (T−1)-frame video, and the T-th frame being ground truth. The videos are pre-processed to video blocks the same as in the training process. The last frame per video block is used as the ground truth frame and the rest of the frames are used for the prediction of the last frame. The video blocks are passed to the future frame prediction model 78′ from the Database 2, at 60. An anomaly score is computed, at 102, based on the ground-truth frame and the predicted frame and generating a threshold value 104 for the detection of anomalies. If the anomaly score is greater than and/or equal to the threshold value display/visualization is provided to the user, at 106. In FIG. 8 the flowchart 108 is shown for the test process. As indicated in connection with FIG. 7, the video comes in at 110 and is loaded into the fine-tuned model 112, together with the pre-trained and the fine-tuned model in the Database 2, at 60. When the fine-tuned model is loaded future frame prediction is conducted at 114. As indicated, the video blocks are passed to the future frame prediction model for the future frame prediction, at 114. The anomaly score is computed at 116, based on the ground-truth frame in the predicted frame. The pre-determined threshold value for the detection of anomalies is performed at 118. If the anomaly score is less than the preselected threshold value the frames/videos are stored at 120 in the Database 1, at 54. On the other hand, if it is determined, at 118, that the anomaly score is greater than a threshold value display/visit visualization is enabled at 122. Once the user is provided with the display of the anomalies the user can study same for further analysis and visualization.

With cloud-based applications and data storage becoming an ever-increasing part of the IT landscape, the invention's technology is designed to run with optimal effectiveness whether deployed in cloud, camera, server or hybrid topologies. The technology in accordance with the invention uses modern AI “Stack” architecture. Open source code, libraries and methods are utilized to the fullest extent possible.

The invention also makes it possible to incorporate the following design elements and associated functionality:
1. SI and User installable
2. No rules
3. Self-learning
4. Infinitely scalable
5. Tightly integrated with leading VMSs
6. Run on leading GPUs: Nvidia, (AMD and Intel to follow after MVP)
7. Dark Wall Display shows only those screens in which anomalous events are taking place

To date, video surveillance systems have almost invariably been sited on-premises (“on-prem”). The primary reasons for this are:
1. Massive amount of video data (terabytes per day) are generated and stored by large-scale video surveillance networks;
2. Large-scale, security conscious clients have mandated data remain with their organizations' firewalls.

Largely driven by cost considerations, the on-prem mindset of certain users has begun change as organizations have become increasingly comfortable with migrating applications and data to the cloud.

Another emerging trend is that major camera manufacturers—Axis and Hanwha—have begun to offer video cameras with on-board GPUs. This edge-based processing power will enable camera manufacturers to embed the invention in their cameras, and at-the-edge event detection will move from possibility to reality.

The invention intends to capitalize on the emergence of edge- and cloud-based computing platforms:
1. GPU equipped cameras running the invention will transmit only exception-based (anomaly) information across the network, minimizing impact to network traffic. Processing capabilities that had once been confined to on-prem servers can now be distributed at the edge.
2. Enhanced filtering techniques mean only a fraction of video data—true(actual) anomalies—need be sent to the cloud for storage and higher-ordering processing
3. Customer video data stored in the cloud may be “abstracted and extracted” by the invention's cloud-based deep learning engines. Within that environment, the invention can aggregate, model and analyze data from thousands of global users. Modeling and learning will no longer confined to single users. The invention's technology becomes smarter and smarter and users benefit from having ever increasing levels of detection and interpretation capabilities at their fingertips.

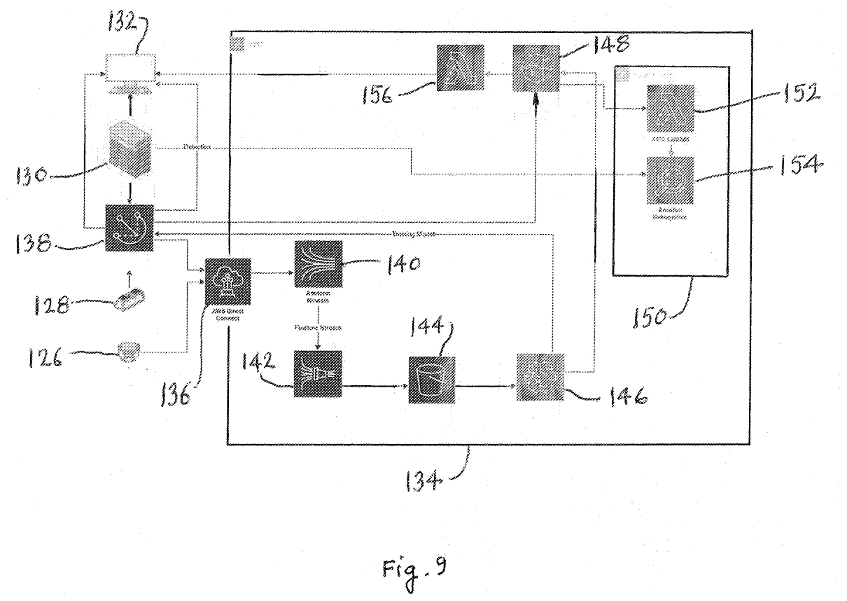

An example of a cloud-based system architecture 124 is illustrated in FIG. 9. In this model an interference engine is run on the edge of the appliance, using Amazon Web Services (AWS) Internet of Things (IoT) Greengrass that is an open source edge runtime and cloud service that helps building, deploying and managing intelligent device software. Although the example is given for use on AWS it will be evident that the cloud based implementation can be carried out on any other cloud—based platform. In this model, the inferencing engine is run on the edge appliance, using AWS IoT Greengrass. Training and model optimization are performed in the cloud.

In FIG. 9 the hardware components include smart camera 126, dumb camera 128 upload or stream video to AWS initial Greengrass Internet of things (IoT) 138 that is an open source edge runtime and cloud service that helps building, deploying and managing intelligent device software. Storage or Database 130 is also connected to the greengrass storage and Database 130 and a monitor or other user interface 132 is coupled to the greengrass interface 138. The dumb camera 128 is said to the AWS Direct Connect 136 that is a cloud service that links directly to AWS and is an alternative to using the initial Internet to use AWS cloud services, being a virtual private cloud (VPC) to launch AWS resources and provides users a virtual private cloud. The AWS Direct connect feeds on Amazon kinesis 140, being an AWS data stream that is configured to move and process data from the direct connect 136 and the stream is directed to the Amazon kinesis data firehose 142 that the extracts, transforms and loads and captures, transforms and delivers streaming data into S3 storage device 144 that allows the data to be optimized, organized. The storage device 144.

The data in in the storage device 144 is used for our training in the Amazon Sage maker 146 that is a AWS service that enables quick and easy building, training and deploying machine learning models. Data from the state 146 forwards the training model to AWS greengrass 138. Data from the Amazon Sagemaker 146 is also passed on to the Amazon as an SNS 148 for means to sloping more crucial servants proposed laws and for structural formula is prone to messages. The SNS 148 also provides data to AWS Lambda 152 of an object classifier for filtering and context 150 and Lambda 156 that are event driven serverless computing platforms that run code in response to events and manage computing resources required by the code. Amazon Rekognition 154, that uses deep neural network models to detect and label scenes in images scalable image analysis, receives data from both Lambda 152 and the storage/data base 130. When Lambda 156 confirms the detection of an anomaly it enables the user interface 132 to exhibit the anomaly.

The invention's IP Suite is built around proven statistical modeling techniques that will generate what is essentially a heatmap of motion vectors. This approach enables motion vectors to be neatly grouped into a 2D map of the camera scene. The scene will be divided into cells Each cell will then be allocated an inversely proportional value based on the frequency and magnitude of motion in that cell and, when that number falls either in the top 1% or bottom 1%, a detection is triggered.

The invention's approach represents a significant advancement over “linear curve” techniques. Our technology will be able to more precisely calculate anomalies based on true direction of motion. Furthermore, accuracy is improved over linear techniques because anomalous motion vectors cannot masquerade as normal motion vectors The system is also designed to detects a lack of motion—if in fact a lack of motion is anomalous to a scene.

While post-event, rules-based video analytics systems can be effective in identifying specific elements occurring in subsets of camera networks, the invention will change the security industry forever when we begin to detect, identify and label specific scenes as they occur in real-time. Scenes that we expect to identify include, but are certainly not limited to, include:
Trespassing; go/no-go zones
Unauthorized access (people/vehicles)
Irregular movement (people/vehicles)
Crowd gathering/dispersion
Violence and aggressive behavior
Medical events requiring immediate response
Suspicious behavior
Slips and falls
Vandalism
Camera tampering
Smoke/fire
Fluid leaks
Floods

Designed to work with virtually any Video Management System or video surveillance camera, the invention will turn existing “record and review” surveillance networks into real-time, situationally aware networks.

Virtually self-installing, the invention will easily scale from a handful to many thousands of cameras. Unlike other video analytics technologies, the invention is not rules-based. Rules-based systems have a number of serious limitations:
Most do not operate in real-time;
Are primarily investigative tools, not useful for prevention;
Require human input—the rules—to initiate a search; officers must have foreknowledge of what they are looking for (e.g., “the man in the red sweater”).

The invention automatically builds comprehensive second-by-second statistical models for each and every camera scene to which it is connected. Once the system has finished modeling its environment (3- to 14-days), it begins to detect and alert security officers in real-time to anomalous events occurring across their networks.

At any given time, no more than 1% of cameras on any video surveillance network typically exhibit anomalous movements. Therefore, the simple addition of the invention's technology to surveillance networks will result in the elimination of 99% of the noise displayed across command center video walls. Additionally, future releases of the invention's technology will filter out various environmental conditions, including swaying branches, shadows, waves, reflections, clouds, and animals walking fence lines. This filtering capability will dramatically reduce the number of nuisance alerts issued by the system and will help ensure optimal levels of officer engagement.

The invention is a significant improvement over the prior art approaches in that it requires only normal videos given (i) that anomalies are rare (ii) anomaly videos are not easy to obtain. The new approach is based on few-shot learning strategy that mimics the human learning process that learns from fewer training videos. The invention deals with video subsequences, i.e., 4/15/fewer frames per second based on the use cases. The invention is composed of several convolutional layer followed by ReLU and normalization Units. The invention uses the future frame predictions for detecting the anomalies. Furthermore, the invention is simple and it is trained from a larger number of few-shot scene-adaptive anomaly detection tasks, where each task corresponds to a particular scene (In each task, the method learns to adapt a pre-trained future frame prediction model using a few frames from the corresponding scene). The invention builds a model to learn the future frame prediction/reconstruction, then the anomaly detection is determined by the difference between the predicted/reconstructed frame and the actual frame. If the difference is larger than a threshold, this frame is considered an anomaly.

The invention identifies and analyses possible anomalies once an anomaly happens (pre-filtering for both storage and computation efficiency). Moreover, the invention is able to do more fine-grained anomaly detection that generates different levels of anomalies. The new model enjoys the ability that is easier to adapt to new environments through several frames of fine-tuning.

Designed to work with virtually any Video Management System or video surveillance camera, the invention will turn existing “record and review” surveillance networks into real-time, situationally aware networks.

Virtually self-installing, the invention will easily scale from a handful to many thousands of cameras. Unlike other video analytics technologies, the invention is not rules-based. Rules-based systems have a number of serious limitations:
Most do not operate in real-time;
Are primarily investigative tools, not useful for prevention;
Require human input—the rules—to initiate a search; officers must have foreknowledge of what they are looking for (e.g., “the man in the red sweater”).

The invention automatically builds comprehensive second-by-second statistical models for each and every camera scene to which it is connected. Once the system has finished modeling its environment (3- to 14-days), it begins to detect and alert security officers in real-time to anomalous events occurring across their networks.

The invention's primary user interface makes it possible for as few as one or two security officers to effectively monitor a 1,000-camera network; something that has been heretofore impossible.

Some of the unusual and unwanted events that the invention will be able to automatically detect include:
Trespassing; go/no-go zones
Unauthorized access (people/vehicles)
Irregular movement (people/vehicles)
Crowd gathering/dispersion
Violence and aggressive behavior
Medical events requiring immediate response
Suspicious behavior
Slips and falls
Vandalism
Camera tampering
Smoke/fire
Fluid leaks
Floods

Special consideration should be given to the systems potential to detect precursory events, such as crowd gathering or stalking. This is considered to be the highest and best use of the invention as it can enable security officers to intervene in unwanted events before they have had time to further escalate. We call this being “closer to prevention.”

The invention's system is designed to detect all anomalous events occurring across entire video surveillance networks. Optimized edge-to-cloud design ensures modeling and event detection take place in the most efficient, cost-effective manner possible. Key characteristics of the invention's technology include:

| | |
|---|---|
| Real-Time | ASTR is designed to detect and alert security |
| | officers to anomalous events occurring across their |
| | networks while those events are actually occurring. |
| No Rules | Because risk doesn't play by the rules, our system |
| | automatically builds comprehensive second-by-second |
| | statistical models of normal movements within each |
| | camera scene. Models are continually updated, enabling |
| | the invention to automatically adjust to changing |
| | environmental conditions and usage patterns. |
| Sees | Rules-based systems focus myopically on identifying |
| Everything | specific people, objects or events-to the exclusion |
| | of everything else that may be occurring across a |
| | network. The invention is capable of detecting events |
| | that otherwise would remain hidden from even the most |
| | highly trained and engaged officers. |
| | The invention sees everything, everywhere. Not just |
| | the “man in the red sweater,” but the car break-in |
| | taking place in the Green Parking Structure, and the |
| | slip-and-fall taking place in Building 2, East |
| | Hallway, Floor 3. |
| Reduces | The images gathered by Video Management Systems are |
| “Noise” | typically displayed across multiple monitors. Video |
| | walls in command centers may display hundreds of |
| | concurrent camera scenes. Unfortunately, humans are |
| | incapable of monitoring massive amount of video |
| | information, so the displayed images amount to little |
| | more than visual noise. |
| | The invention, by contrast, focuses operators' |
| | attention on only scenes displaying unusual movements; |
| | typically, less than 1% of cameras in a network. |
| | Growing smarter over time via advanced modeling, |
| | filtering and scene identification capabilities, the |
| | invention will reduce detection alerts to well below |
| | a 1% threshold. |
| | Note: Filters may also be applied to individual |
| | scenes-e.g., maintenance activities or dorm move-in |
| | day-to greatly reduce the number of unwanted alerts |
| | produced by the system. |
| Resource | The invention's statistical-based methodology is far |
| Efficient | more efficient in the use of hardware and network |
| | resources than other analytics offerings. For example, |
| | while competitive systems may be able to process 30 |
| | camera streams per server, the invention can easily |
| | process 400 or more per 2U server appliance. |
| Unprecedented | The difference between being merely able to use video |
| ROI | to investigate the occurrence of unwanted events and |
| | being able to detect and respond to events in real- |
| | time is so profound that it is difficult to assign a |
| | monetary value to it. |
| | Because the invention imbues existing “record and |
| | review” networks with real-time situational awareness, |
| | we lend new, substantial value (ROI) to sunk |
| | investments in video surveillance infrastructure, such |
| | as cameras, VMSs and post-event analytics tools. We |
| | like to say the invention “turns video surveillance |
| | networks on.” |
| No 3^{rd} | The invention is a self-contained system. It does |
| Party Data | not rely on external data sources that increase |
| | dependencies, costs and administrative burdens. |
| Reduces | Virtually self-installing, implementation of the |
| Complexity | invention will be non-taxing for security integrators |
| | and their customers. This ease of integration will be |
| | viewed by the industry as a uniquely positive |
| | attribute. |
| Infinitely | The invention's self-learning approach allows it to |
| Scalability | scale from single camera installations to those |
| | numbering in the thousands. A 10,000-camera system |
| | will be just as easy to operate and administer as |
| | 10-camera system. |
| Non-Intrusive | The invention searches for and detects anomalous |
| Tech | movements; we do not profile on the basis of skin |
| | color or any other physical attributes. Cases built on |
| | evidence discovered through the use of the invention |
| | are less likely to be thrown out of court since our |
| | technology does not lend itself to the entrapment of |
| | suspects. |
| | Furthermore, because the statistical approach |
| | “anonymizes” data, the invention's technology is |
| | expected to fully comply with the EU's General Data |
| | Protection Regulation. |
| Edge-to-Cloud | The invention is designed to place intelligence where |
| Support | it can be best utilized. Our goal is to place modeling |
| | and detection capabilities as close to actual events |
| | as possible. In the case of emerging GPU-equipped |
| | cameras, this becomes the camera itself. Migration |
| | toward the edge will increase overall system |
| | effectiveness while reducing impacts to networks and |
| | data centers, an especially good approach for smaller |
| | customers. |
| | Migration toward the cloud will enable deep learning |
| | methodologies to be applied to exception-based |
| | (anomalous) data across a global repository of video |
| | data. The invention will aggregate user data to |
| | continually increase the power and accuracy of our |
| | modeling and detection engines. This approach will |
| | enable us to deliver ever increasing levels of value |
| | to our customers. |

The invention's system is designed to detect all anomalous events occurring across entire video surveillance networks. Optimized edge-to-cloud design ensures modeling and event detection take place in the most efficient, cost-effective manner possible. Key characteristics of the invention's technology include:

| | |
|---|---|
| Real-Time | ASTR is designed to detect and alert security |
| | officers to anomalous events occurring across their |
| | networks while those events are actually occurring. |
| No Rules | Because risk doesn't play by the rules, our system |
| | automatically builds comprehensive second-by-second |
| | statistical models of normal movements within each |
| | camera scene. Models are continually updated, enabling |
| | the invention to automatically adjust to changing |
| | environmental conditions and usage patterns. |
| Sees | Rules-based systems focus myopically on identifying |
| Everything | specific people, objects or events-to the exclusion |
| | of everything else that may be occurring across a |
| | network. The invention is capable of detecting events |
| | that otherwise would remain hidden from even the most |
| | highly trained and engaged officers. |
| | The invention sees everything, everywhere. Not just |
| | the “man in the red sweater,” but the car break-in |
| | taking place in the Green Parking Structure, and the |
| | slip-and-fall taking place in Building 2, East |
| | Hallway, Floor 3. |
| Reduces | The images gathered by Video Management Systems are |
| “Noise” | typically displayed across multiple monitors. Video |
| | walls in command centers may display hundreds of |
| | concurrent camera scenes. Unfortunately, humans are |
| | incapable of monitoring massive amount of video |
| | information, so the displayed images amount to little |
| | more than visual noise. |
| | The invention, by contrast, focuses operators' |
| | attention on only scenes displaying unusual movements; |
| | typically, less than 1% of cameras in a network. |
| | Growing smarter over time via advanced modeling, |
| | filtering and scene identification capabilities, the |
| | invention will reduce detection alerts to well below |
| | a 1% threshold. |
| | Note: Filters may also be applied to individual |
| | scenes-e.g., maintenance activities or dorm move-in |
| | day-to greatly reduce the number of unwanted alerts |
| | produced by the system. |
| Resource | The invention's statistical-based methodology is far |
| Efficient | more efficient in the use of hardware and network |
| | resources than other analytics offerings. For example, |
| | while competitive systems may be able to process 30 |
| | camera streams per server, the invention can easily |
| | process 400 or more per 2U server appliance. |
| Unprecedented | The difference between being merely able to use video |
| ROI | to investigate the occurrence of unwanted events and |
| | being able to detect and respond to events in real- |
| | time is so profound that it is difficult to assign a |
| | monetary value to it. |
| | Because the invention imbues existing “record and |
| | review” networks with real-time situational awareness, |
| | we lend new, substantial value (ROI) to sunk |
| | investments in video surveillance infrastructure, |
| | such as cameras, VMSs and post-event analytics tools. |
| | We like to say the invention “turns video surveillance |
| | networks on.” |
| No 3^{rd} | The invention is a self-contained system. It does not |
| Party Data | rely on external data sources that increase |
| | dependencies, costs and administrative burdens. |
| Reduces | Virtually self-installing, implementation of the |
| Complexity | invention will be non-taxing for security integrators |
| | and their customers. This ease of integration will be |
| | viewed by the industry as a uniquely positive attribute. |
| Infinitely | The invention's self-learning approach allows it to |
| Scalability | scale from single camera installations to those |
| | numbering in the thousands. A 10,000-camera system |
| | will be just as easy to operate and administer as |
| | 10-camera system. |
| Non-Intrusive | The invention searches for and detects anomalous |
| Tech | movements; we do not profile on the basis of skin |
| | color or any other physical attributes. Cases built |
| | on evidence discovered through the use of the |
| | invention are less likely to be thrown out of court |
| | since our technology does not lend itself to the |
| | entrapment of suspects. |
| | Furthermore, because our statistical approach |
| | “anonymizes” data, the invention's technology is |
| | expected to fully comply with the EU's General Data |
| | Protection Regulation. |
| Edge-to-Cloud | The invention is designed to place intelligence where |
| Support | it can be best utilized. Our goal is to place modeling |
| | and detection capabilities as close to actual events |
| | as possible. In the case of emerging GPU-equipped |
| | cameras, this becomes the camera itself. Migration |
| | toward the edge will increase overall system |
| | effectiveness while reducing impacts to networks and |
| | data centers, an especially good approach for smaller |
| | customers. |
| | Migration toward the cloud will enable deep learning |
| | methodologies to be applied to exception-based |
| | (anomalous) data across a global repository of video |
| | data. The invention will aggregate user data to |
| | continually increase the power and accuracy of our |
| | modeling and detection engines. This approach will |
| | enable us to deliver ever increasing levels of value |
| | to customers. |

Although certain preferred exemplary embodiments of the present invention have been shown and described in detail, it should be understood that various changes and modifications may be made therein without departing from the scope of the appended claims.

1. A computer implemented method for real-time anomaly detection from video streaming data, and/or finding anomaly video frames from stored videos, the method comprising the steps of:
meta learning: using the videos collected from multiple scenes (e.g., shopping mall, airport, car parking area, etc.) that contains only normal/common activities; training from a larger number of few-shot scene-adaptive anomaly detection tasks, where each task corresponds to a particular scene, in each task learning to adapt a pre-trained future frame prediction model using a few frames from a corresponding scene;
meta fine-tuning: given a few frames from a new target scene (e.g., coffee shop which does not appear in the training data), the meta-learner being used to adapt a pre-trained model to said scene, the adapted model being expected to work well on other frames from this target scene, the few frames of the new target scene can be obtained during a camera calibration process, building a model to learn the future frame prediction/reconstruction, then the anomaly detection is determined by the difference between a predicted/reconstructed frame and the actual frame; and
meta testing/test stage, the model being configured to detect anomalies for different/multiple new/unseen scenarios/environments.

2. A computer implemented method according to claim 1, wherein the memory is used to store the output models and video frames. The output models can be pre-trained and/or fine-tuned models.

3. A computer implemented method according to claim 1, wherein the anomaly detection is determined based on future frame prediction model.

4. A computer implemented method according to claim 1, wherein the future frame prediction model is fine-tuned given fewer frames from a new/unseen scenario.

5. A computer implemented method according to claim 1, wherein the output model is then used for future frame prediction.

6. An anomaly detection system comprising: a video data source; a processor coupled to the video data source and configured to receive video data streams from the video data source; at least one storage device coupled to the processor and configured to store data therein; a display coupled to the processor configured to display video data to a user, the processor being further configured to:
obtain training videos, which are only normal videos, can be either real-time streaming data, online or streaming videos or stored historical videos train a future frame prediction model store the pre-trained future frame prediction model into a database accept a fewer number of frames from a new scenario use fewer frames for the fine-tuning of the future frame prediction model store the output model into a database use the model for future frame prediction of a new scene/unseen environment compare the difference between the predicted frame and the ground truth frame(either from a real-time video streaming or stored video frame) compare the difference to the pre-defined threshold value to determine whether there are anomalies show the video frame or frames that contain the anomalies to the user.

7. An anomaly detection system according to the claim 6, wherein the processor is further configured to:
videos from multiple scenarios (can be either real-time video streaming or stored videos, can be obtained from Youtube, benchmark anomaly detection datasets, stored videos captured from different sites, etc.) only normal videos from multiple scenarios are used as inputs determining the length of video clip and stride step size for the video clip each video is divided into equal-sized video clips based on the length and stride step size the length of video clip and the stride step size are determined based on the scenarios the model is trained based on the normal videos from different scenarios the model learns the weights based on the input of each video clip the model learns to better predict the last video frame given the first several video frames the learning process is controlled by a loss the loss is based on the ground-truth/actual frame and the predicted video frame output from the model the loss is computed based on the pixels (i.e., L1 or L2-norm) and/or gradients between pixels outputs from the training: a future frame prediction model the output model can be easily adapted to multiple new scenarios/unseen environments the model is saved to a database the model is used for later future frame prediction of an unseen scenario/environment.

8. An anomaly detection system according to the claim 6, wherein the processor is further configured to:
inputs for the testing: resized fewer video frames from a new scene the fewer video frames can be obtained from camera calibration stage the number of input frames can be 1, 5, or 10 depends on the scenarios the pre-trained model is retrieved from a database the model is then fine-tuned based on the frames obtained from a new scenario/unseen environment the fine-tuned model is saved to a database the fine-tuned model is used to predict the next frame for the new scenario/unseen environment outputs from the test: predicted next frame (with the same resolution as the inputs).

9. An anomaly detection system according to the claim 6, wherein the processor is further configured:
to obtain the predicted video frame from the model the predicted frame has the same resolution as the input video frames the output predicted frame is further compared to the actual frame the actual/ground-truth frame can be either from the video streaming, or stored video frame.

10. An anomaly detection system according to the claim 6, wherein the processor is further configured to:
display the frames that contain possible anomalies the anomaly frames are determined based on the threshold value the threshold value is pre-defined different scenarios/environments may have different threshold values (the threshold values are scenario-based) the anomaly is determined by the difference between the pre-dicted/reconstructed frame and the actual frame the computation of difference is based on pixels (i.e., L1 or L2-norm) and/or gradients between pixels the difference value is normalized between 0 and 1 if the difference is larger than a threshold, this frame is considered an anomaly the anomaly frame/video is displayed to the user, and the normal frame/video is stored for later inspection.

11. A computer implemented method according claim 1, wherein the anomaly detection is determined by the difference between the predicted/reconstructed frame and the actual frame. If the difference is larger than a threshold, this frame is considered an anomaly.

12. An anomaly detection system comprising: a video data source; a processor coupled to the video data source and configured to receive video data streams from the video data source; at least one storage device coupled to the processor and configured to store data therein; a display coupled to the processor configured to display video data to a user. the processor being further configured to:
obtain training videos, which are only normal videos, can be either real-time streaming data, YouTube videos (or any other online resources), or stored historical videos train a future frame prediction model store the pre-trained future frame prediction model into a database accept a fewer number of frames from a new scenario use the fewer frames for the fine-tuning of the pre-trained future frame prediction model store the fine-tuned model into a database use the fine-tuned model for the future frame pre-diction of a new scene compare the difference between the predicted frame and the ground truth frame (either from areal-time video streaming or stored video frame) compare the difference to the pre-defined threshold value to determine whether there are anomalies show the video frame or frames that contain the anomalies to the user.

13. An anomaly detection system according to the claim 12, wherein the processor is further configured to:
inputs for the training: videos come from various scenarios the system only accepts the normal videos as in-puts the training data here can be obtained from Youtube, benchmark anomaly detection datasets, stored videos captured from different sites, etc. the model is trained based on the normal videos from different scenarios outputs from the training: a model that can be easily adapted to multiple scenarios the pre-trained model is saved to a database the pre-trained model is used for future frame prediction of an unseen scenario/environment.

14. An anomaly detection system according to the claim 12, wherein the processor is further configured to:
to obtain the predicted frame from the model; the output predicted frame is further compared to the actual frame comes from the video streaming.

15. An anomaly detection system according to the claim 12, wherein the processor is further configured to:
display the anomaly frames based on the threshold value the threshold value is pre-defined the threshold value is based on the scenarios the anomaly detection is determined by the difference between the predicted/reconstructed frame and the actual frame if the difference is larger than a threshold, this frame is considered an anomaly the frame/video is displayed to the user.
